(19) United States
(12) Patent Application Publication
(10) Pub. No.: US 2023/0253003 A1
(43) Pub. Date: Aug. 10, 2023

(54) SPEECH PROCESSING METHOD AND SPEECH PROCESSING APPARATUS

(71) Applicant: BEIJING SOGOU TECHNOLOGY DEVELOPMENT CO., LTD., Beijing (CN)

(72) Inventor: Yun LIU, Beijing (CN)

(21) Appl. No.: 18/300,500

(22) Filed: Apr. 14, 2023

Related U.S. Application Data
(63) Continuation of application No. PCT/CN2021/103220, filed on Jun. 29, 2021.

(30) Foreign Application Priority Data
Nov. 27, 2020 (CN) 202011365146.8

(51) Int. Cl. G10L 21/0232; G10L 13/02

(52) U.S. Cl. CPC G10L 21/0232; G10L 13/02

(57) ABSTRACT

The embodiments of this application disclose a speech processing method and a speech processing apparatus. The speech processing method includes obtaining a first spectrum of a noisy speech in a complex number domain; performing subband division on the first spectrum to obtain a first subband spectrum in the complex number domain; processing the first subband spectrum based on a pre-trained noise reduction model to obtain a second subband spectrum of a target speech in the noisy speech in the complex number domain; performing subband restoration on the second subband spectrum to obtain a second spectrum in the complex number domain; and synthesizing the target speech based on the second spectrum.

### RELATED APPLICATIONS

This application is a continuation of PCT Application No. PCT/CN2021/103220, filed on Jun. 29, 2021, which in turn claims priority to China Patent Application No. 202011365146.8, filed with the State Intellectual Property Office on Nov. 27, 2020, and entitled “SPEECH PROCESSING METHOD AND APPARATUS AND SPEECH PROCESSING APPARATUS”. The two applications are incorporated herein by reference in their entirety.

### FIELD OF THE TECHNOLOGY

Embodiments of this application relate to the field of computer technologies, and in particular, to a speech processing method and a speech processing apparatus.

### BACKGROUND OF THE DISCLOSURE

With the development of computer technologies, speech interaction products, for example, smart speakers and recording pens are widely used. Speech interaction products receive noise and reverberation signals and the like while receiving a speech signal. As such, to avoid affecting the speech recognition effect, it is usually necessary to extract a target speech (for example, a relatively clean speech) from a noisy speech and reverberation.

### SUMMARY

Embodiments of this application propose a speech processing method and a speech processing apparatus, so as to solve a technical problem in the related art that the clarity of a speech after noise reduction is low due to the imbalance of high and low frequency information in the speech.

Embodiments of the present disclosure provide a speech processing method. The method includes obtaining a first spectrum of a noisy speech in a complex number domain; performing subband division on the first spectrum to obtain a first subband spectrum in the complex number domain; processing the first subband spectrum based on a pre-trained noise reduction model to obtain a second subband spectrum of a target speech in the noisy speech in the complex number domain; performing subband restoration on the second subband spectrum to obtain a second spectrum in the complex number domain; and synthesizing the target speech based on the second spectrum.

Embodiments of the present disclosure provide a speech processing apparatus, including: an obtaining unit, configured to obtain a first spectrum of a noisy speech in a complex number domain; a subband division unit, configured to perform subband division on the first spectrum to obtain a first subband spectrum in the complex number domain; a noise reduction unit, configured to process the first subband spectrum based on a pre-trained noise reduction model to obtain a second subband spectrum of a target speech in the noisy speech in the complex number domain; a subband restoration unit, configured to perform subband restoration on the second subband spectrum to obtain a second spectrum in the complex number domain; and a synthesis unit, configured to synthesize the target speech based on the second spectrum.

Embodiments of the present disclosure provide a non-transitory computer readable medium, storing a computer program, when the program is executed by a processor, the method described in the first aspect is performed.

In the speech processing method and the speech processing apparatus in the embodiments of this application, a first spectrum of a noisy speech in a complex number domain is obtained; then subband division is performed on the first spectrum to obtain a first subband spectrum in the complex number domain; then the first subband spectrum is processed based on a pre-trained noise reduction model to obtain a second subband spectrum of a target speech in the noisy speech in the complex number domain; then subband restoration is performed for the second subband spectrum to obtain a second spectrum in the complex number domain; and the target speech is finally synthesized based on the second spectrum. Since subband division is performed on the first spectrum of the noisy speech in the complex number domain before noise reduction processing, both the high and low frequency information in the noisy speech can be effectively processed, the imbalance (for example, severe loss of high frequency speech information) of the high and low frequency information in the speech can be resolved, and the clarity of the speech after noise reduction is improved.

### BRIEF DESCRIPTION OF THE DRAWINGS

Other characteristics, objectives, and advantages of this application will become more apparent by reading the detailed description of non-limiting embodiments made with reference to the following drawings:

FIG. 1 is a flowchart of a speech processing method according to an embodiment of this application;

FIG. 2 is a schematic diagram of subband division according to this application;

FIG. 3 is a schematic structural diagram of a complex convolutional recurrent network according to this application;

FIG. 4 is a schematic structural diagram of a speech processing apparatus according to an embodiment of this application;

FIG. 5 is a schematic structural diagram of a speech processing apparatus according to this application; and

FIG. 6 is a schematic structural diagram of a server according to an embodiment of this application.

### DESCRIPTION OF EMBODIMENTS

This application is further described in detail below with reference to the accompanying drawings and embodiments. It may be understood that, the specific embodiments described herein are merely used for illustrating a related disclosure, but are not limited to the disclosure. In addition, for ease of description, the accompanying drawings only show parts relevant to the related disclosure.

The embodiments in this application and features in the embodiments can be combined with each other in the case of no conflict. This application is described in detail below with reference to the accompanying drawings and embodiments.

In many speech processing applications, a spectrum of a noisy speech is directly inputted into an existing noise reduction model, to obtain a spectrum of a speech after noise reduction, and then a target speech is then synthesized based on the obtained spectrum of the speech after noise reduction.

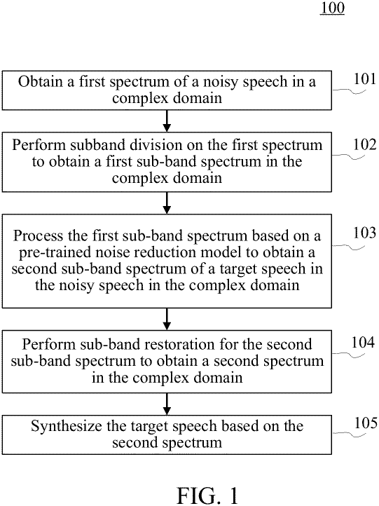

FIG. 1 shows a flow 100 of a speech processing method according to an embodiment of this application. The speech processing method can be run on various electronic devices, including but not limited to: servers, smartphones, tablet computers, e-book readers, moving picture experts group audio layer III (MP3) players, moving picture experts group audio layer IV (MP4) players, laptop computers, on-board computers, desktop computers, set-top boxes, smart TVs, wearable devices, etc.

The speech processing method in this embodiment may include the following steps:

Step 101: Obtain a first spectrum of a noisy speech in a complex number domain.

In this embodiment, an execution body of the speech processing method (for example, the above electronic device) may perform time-frequency analysis on the noisy speech to obtain a spectrum of the noisy speech in the complex number domain, and the spectrum may be called the first spectrum.

Herein, the noisy speech is a speech having noise. The noisy speech may be a noisy speech collected by the execution body, for example, a speech with background noise, a speech with reverberation, and a near and far human speech. The complex number domain is a number domain formed by all complex number sets in a form a+bi in a four arithmetic operation. a is a real part, b is an imaginary part, and i is an imaginary unit. An amplitude and a phase of a speech signal can be determined based on the real part and the imaginary part. In embodiments consistent with the present disclosure, a real part and an imaginary part in an expression of a spectrum corresponding to each time point can be combined into a form of a two-dimensional vector. Therefore, after time-frequency analysis is performed on the noisy speech, the spectrum of the noisy speech in the complex number domain can be represented in a form of a two-dimensional vector sequence or in a form of a matrix.

In this embodiment, the execution body may perform time-frequency analysis (TFA) on the noisy speech by using various time-frequency analysis methods for the speech signal. Time-frequency analysis is a method for determining time-frequency distribution. The time-frequency distribution can be represented by a joint function of time and frequency (also called a time-frequency distribution function). The joint function can be used to describe energy density or strength of a signal at different times and frequencies. By performing time-frequency analysis on the noisy speech, information such as an instantaneous frequency and amplitude value of the noisy speech at each moment can be obtained.

In embodiments consistent with the present disclosure, various common time-frequency distribution functions can be used for time-frequency analysis of the noisy speech. For example, short-time Fourier transform (STFT), a Cohen distribution function, or modified Wigner distribution may be used. This is not limited herein.

The short-time Fourier transform is used as an example. The short-time Fourier transform is mathematical transform related to Fourier transform, and is used to determine a frequency and a phase of a sine wave in a local area of a time-varying signal. The short-time Fourier transform has two variables, that is, time and frequency. Windowing is performed based on a sliding window function and a time-domain signal of a corresponding segment is multiplied, to obtain a windowed signal. Then, Fourier transform is performed on the windowed signal to obtain a short-time Fourier transform coefficient (including a real part and an imaginary part) in a form of a complex number. In this way, the noisy speech in time domain can be used as a processing object, and Fourier transform is sequentially performed on each segment of the noisy speech, to obtain a corresponding short-time Fourier transform coefficient of each segment. In embodiments consistent with the present disclosure, the short-time Fourier transform coefficient of each segment can be combined into a form of a two-dimensional vector. Therefore, after time-frequency analysis is performed on the noisy speech, the first spectrum of the noisy speech in the complex number domain can be represented in a form of a two-dimensional vector sequence or in a form of a matrix.

Step 102: Perform subband division on the first spectrum to obtain a first subband spectrum in the complex number domain.

In this embodiment, the execution body may perform subband division on the first spectrum to obtain the first subband spectrum in the complex number domain. The subbands may also be referred to as sub-frequency bands, and each subband is a part of the frequency domain of the first spectrum. Each subband after subband division corresponds to a first subband spectrum. If 4 subbands are obtained through division, there are 4 corresponding first subband spectra.

In embodiments consistent with the present disclosure, subband division may be performed on the first spectrum in a frequency domain subband division method, or subband division may be performed on the first spectrum in a time domain subband division method. This is not limited in this embodiment.

The frequency domain subband division method is used as an example. The frequency domain of the first spectrum may be first divided into a plurality of subbands. The frequency domain of the first spectrum is a frequency interval from the lowest frequency to the highest frequency in the first spectrum. Then, the first spectrum may be divided according to the divided subbands to obtain first subband spectra in one-to-one correspondence with the divided subbands.

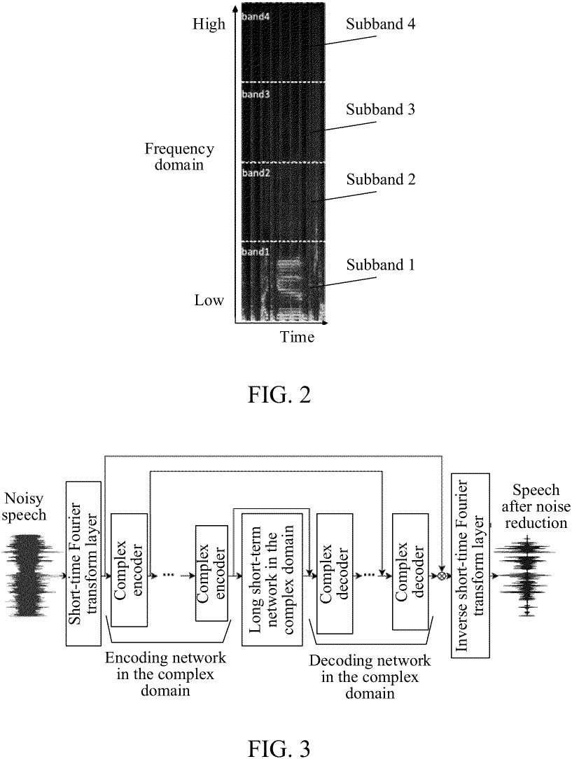

Herein, the subbands may be obtained through division in an even division method, or may be obtained through division in a non-even division method. The even division method is used as an example. Referring to a schematic diagram of subband division shown in FIG. 2, the frequency domain of the first spectrum can be evenly divided into 4 subbands, that is, a subband 1 from the lowest frequency to ¼ of the highest frequency, a subband 2 from ¼ of the highest frequency to ½ of the highest frequency, a subband 3 from ½ of the highest frequency to ¾ of the highest frequency, and a subband 4 from ¾ of the highest frequency to the highest frequency.

By performing subband division on the first spectrum, the first spectrum can be divided into a plurality of first subband spectra. Since different first subband spectra have different frequency ranges, in subsequent steps, the first subband spectra of different frequency ranges are processed independently. This can make full use of information in each frequency range and resolve the imbalance of high and low frequency information in a speech (for example, serious loss of high frequency speech information), so as to improve the clarity of the speech after noise reduction.

Step 103: Process the first subband spectrum based on a pre-trained noise reduction model to obtain a second subband spectrum of a target speech in the noisy speech in the complex number domain.

In this embodiment, a pre-trained noise reduction model may be stored in the execution body. The noise reduction model can perform noise reduction processing on the spectrum (or a subband spectrum) of the noisy speech. The execution body may process the first subband spectrum based on the noise reduction model, to obtain the second subband spectrum of the target speech in the noisy speech in the complex number domain. The noise reduction model may be pre-trained by using a machine learning method (for example, a supervised learning method). Herein, the noise reduction model can be used to process the spectrum in the complex number domain and output the spectrum after noise reduction in the complex number domain.

Compared with a real number domain (which only includes amplitude information and does not include phase information), the spectrum in the complex number domain includes not only amplitude information but also phase information. The noise reduction model can process the spectrum in the complex number domain, so that an amplitude and a phase can be corrected simultaneously during the processing to achieve noise reduction. As a result, a predicted phase of a pure speech is more accurate, the degree of speech distortion is reduced, and the effect of speech noise reduction is improved.

In some embodiments consistent with this disclosure, the noise reduction model may be obtained through training based on a deep complex convolutional recurrent network (DCCRN). As shown in a structural diagram of a complex convolutional recurrent network in FIG. 3, the deep complex convolutional recurrent network can include an encoding network in the complex number domain, a decoding network in the complex number domain, and a long short-term memory network (LSTM) in the complex number domain. The encoding network and the decoding network may be connected through the long short-term memory network.

The encoding network may include a plurality of layers of complex encoders (CE). Each layer of complex encoder includes a complex convolution (Complex Convolution) layer, a batch normalization (Batch Normalization, BN) layer, and an activation unit layer. The complex convolution layer can perform a convolution operation on the spectrum in the complex number domain. The batch normalization layer is configured to improve the performance and stability of a neural network. The activation unit layer can map an input of a neuron to an output end through an activation function (for example, PRelu). The decoding network may include a plurality of layers of complex decoders (CD), and each layer of complex decoder includes a complex deconvolution layer, a batch normalization layer, and an activation unit layer. The deconvolution layer is also called a transposed convolution layer.

In addition, the deep complex convolutional recurrent network can use a skip connection structure. The skip connection structure can be specifically represented as follows: a number of layers of the complex encoder in the encoding network may be the same as a number of layers of the complex decoder in the decoding network, and the complex encoder in the encoding network and the complex decoder in a reverse order in the decoding network are in a one-to-one correspondence and are connected. That is, the first layer of complex encoder in the encoding network is connected to the last layer of complex decoder in the decoding network, the second layer of complex encoder in the encoding network is connected to the penultimate layer of complex decoder in the decoding network, and the like.

As an example, 6 layers of complex encoders may be included in the encoding network, and 6 layers of complex decoders may be included in the decoding network. A layer 1 complex encoder of the encoding network is connected to a layer 6 complex decoder of the decoding network. A layer 2 complex encoder of the encoding network is connected to a layer 5 complex decoder of the decoding network. A layer 3 complex encoder of the encoding network is connected to a layer 4 complex decoder of the decoding network. A layer 4 complex encoder of the encoding network is connected to a layer 3 complex decoder of the decoding network. A layer 5 complex encoder of the encoding network is connected to a layer 2 complex decoder of the decoding network. A layer 6 complex encoder of the encoding network is connected to a layer 1 complex decoder of the decoding network. Herein, a number of channels corresponding to the encoding network can gradually increase from 2, for example, increase to 1024. The number of channels of the decoding network can gradually decrease from 1024 to 2.

In some embodiments consistent with this disclosure, the complex convolution layer in the complex encoder may include a first real part convolution kernel (which can be denoted as Wr) and a first imaginary part convolution kernel (which can be denoted as Wi). The complex encoder can use the first real part convolution kernel and the first imaginary part convolution kernel to perform the following operations.

First, convolving a received real part (which can be denoted as Xr) and a received imaginary part (which can be denoted as Xi) through the first real part convolution kernel, to obtain a first output (which can be denoted as Xr*Wr, where * means convolution) and a second output (which can be denoted as Xi*Wr), and convolving a received real part and a received imaginary part through the first imaginary part convolution kernel, to obtain a third output (which can be denoted as Xr* Wi) and a fourth output (which can be denoted as Xi*Wi). For a complex encoder that is not of the first layer, the real part and the imaginary part received by the complex encoder may be a real part and an imaginary part outputted by a network structure of a previous layer. For a complex encoder of the first layer, the real part and the imaginary part received by the complex encoder may be a real part and an imaginary part of the first subband spectrum.

Then, a complex multiplication operation is performed on the first output, the second output, the third output, and the fourth output based on a complex multiplication rule, to obtain a first operation result (which can be denoted as Fout) in the complex number domain. Refer to the formula below:

$$\text{Fout=} \left(\text{Xr* Wr- Xi* Wi}\right) \text{+ j} \left(\text{Xr*Wi- Xi*Wr}\right)$$

where j may represent an imaginary unit, the real part of the first operation result is Xr*Wr- Xi*Wi, and the imaginary part of the first operation result is Xr*Wi- Xi*Wr.

Then, the first operation result is sequentially processed through the batch normalization layer and the activation unit layer in the complex encoder, to obtain an encoding result in the complex number domain, where the encoding result includes a real part and an imaginary part.

Finally, the real part and the imaginary part of the encoding result are inputted to a network structure of a next layer. Specifically, for a complex encoder that is not of the last layer, the complex encoder can input the real part and the imaginary part of the encoding result in the complex number domain to the complex encoder of the next layer and a corresponding complex decoder thereof. For the complex encoder of the last layer, the complex encoder can input the real part and the imaginary part of the encoding result in the complex number domain to the long short-term memory network in the complex number domain and a corresponding complex decoder thereof.

By setting the first real part convolution kernel and the first imaginary part convolution kernel at the complex convolution layer, the real part and the imaginary part of the spectrum can be processed respectively. Then, output results of the real part and the imaginary part are correlated based on a complex multiplication rule, which can effectively improve the estimation accuracy of the real part and the imaginary part.

In some embodiments consistent with this disclosure, the long short-term memory network in the complex number domain may include a first long short-term memory network (which can be denoted as LSTMr) and a second long short-term memory network (which can be denoted as LSTMi). The long short-term memory network in the complex number domain can perform the following processing procedure on the encoding result outputted by the complex encoder of the last layer.

First, processing, through the first long short-term memory network, the real part (which can be denoted as X′r) and the imaginary part (which can be denoted as X′ i) in the encoding result outputted by the complex encoder of the last layer, to obtain a fifth output (which can be denoted as Frr) and a sixth output (which can be denoted as Fir); processing, through the second long short-term memory network, the real part and the imaginary part in the encoding result outputted by the complex encoder of the last layer, to obtain a seventh output (which can be denoted as Fri) and an eighth output (which can be denoted as Fii). Frr= LSTMr(X′r), Fir= LSTMr(X ‘i), Fri=LSTMi(X′r), and Fii=LSTMi(X′i). LSTMr( ) represents a process of processing through the first long short-term memory network LSTMr. LSTMi( ) represents a process of processing through the second long short-term memory network LSTMi.

Then, a complex multiplication operation is performed on the fifth output, the sixth output, the seventh output, and the eighth output based on a complex multiplication rule, to obtain a second operation result (which can be denoted as F′out) in the complex number domain, where the second operation result includes a real part and an imaginary part. Refer to the formula below:

$$\text{F′out=} \left(\text{Frr- Fii}\right) \text{+j} \left(\text{Fri- Fir}\right)$$

Finally, the real part and the imaginary part of the second operation result are inputted to a first layer of complex decoder in the decoding network in the complex number domain. The long short-term memory network may further include a fully connected layer to adjust a dimension of output data.

The first long short-term memory network LSTMr and the second long short-term memory network LSTMi can form a set of long short-term memory networks in the complex number domain. In the deep complex convolutional recurrent network, the long short-term memory network in the complex number domain is not limited to one set, and can also be two or more sets. Two sets of long short-term memory networks in the complex number domain are used as an example. Each set of long short-term memory networks in the complex number domain includes a first long short-term memory network LSTMr and a second long short-term memory network LSTMi, and parameters can be different. After the first set of long short-term memory networks obtains the operation result in the complex number domain, the real part and the imaginary part of the second operation result can be inputted to the second set of long short-term memory networks. The second set of complex long short-term memory networks can perform data processing according to the above operation process, and input the obtained operation result in the complex number domain to the first layer of complex decoder in the decoding network in the complex number domain.

By setting the first long short-term memory network and the first long short-term memory network, the real part and the imaginary part of the spectrum can be processed respectively. Then, output results of the real part and the imaginary part are correlated based on a complex multiplication rule, which can effectively improve the estimation accuracy of the real part and the imaginary part.

In some embodiments consistent with this disclosure, the complex convolution layer in the complex encoder may include a first real part convolution kernel (which can be denoted as W′r) and a first imaginary part convolution kernel (which can be denoted as W′i). Similar to the complex convolution layer in the complex encoder, the complex deconvolution layer in the complex decoder can use the second real part convolution kernel and the second imaginary part convolution kernel to perform the following operations.

First, convolving a received real part (which can be denoted as X″r) and a received imaginary part (which can be denoted as X″i) through the second real part convolution kernel, to obtain a ninth output (which can be denoted as X″r*W′r) and a tenth output (which can be denoted as X″i*W′r), and convolving a received real part and a received imaginary part through the second imaginary part convolution kernel, to obtain an eleventh output (which can be denoted as X″r*W′i) and a twelfth output (which can be denoted as X″i*W′i). For each layer of complex decoder, the real part and the imaginary part received by the complex decoder can be formed by combining a result outputted by the network structure of the previous layer and an encoding result outputted by a corresponding complex encoder thereof, for example, obtained after performing a complex multiplication operation. For the complex decoder of the first layer, the network structure of the upper layer is a long short-term memory network. For a complex decoder that is not of the first layer, the network structure of the upper layer is a complex decoder of the upper layer.

Then, a complex multiplication operation is performed on the ninth output, the tenth output, the eleventh output, and the twelfth output based on a complex multiplication rule, to obtain a third operation result (which can be denoted as F″ out) in the complex number domain. Refer to the formula below:

$$\text{F″out=} \left(\text{X″r* W′r} - \text{X″i* W′i}\right) \text{+ j} \left(\text{X″r*W′i} - \text{X″i*W′r}\right)$$

The real part of the third operation result is X″r*W′r- X″i*W′i i and the imaginary part of the third operation result is X″r*W′i- X″i*W′r.

Then, the third operation result is sequentially processed through the batch normalization layer and the activation unit layer in the complex decoder, to obtain a decoding result in the complex number domain, where the decoding result includes a real part and an imaginary part.

Finally, when there is a next layer of complex decoder, the real part and the imaginary part in the decoding result are inputted to the next layer of complex decoder. If there is no complex decoder of the next layer, the decoding result outputted by the complex decoder of this layer can be used as a final output result.

By setting the second real part convolution kernel and the second imaginary part convolution kernel at the complex deconvolution layer, the real part and the imaginary part of the spectrum can be processed respectively. Then, output results of the real part and the imaginary part are correlated based on a complex multiplication rule, which can effectively improve the estimation accuracy of the real part and the imaginary part.

In some embodiments consistent with this disclosure, as shown in FIG. 3, the deep complex convolutional recurrent network may further include a short-time Fourier transform layer and an inverse short-time Fourier transform layer. The noise reduction model can be obtained by training the deep complex convolutional recurrent network shown in FIG. 3. Specifically, the training process can include the following sub-steps.

A first step is as follows: obtaining a speech sample set.

Herein, the speech sample set includes a sample of the noisy speech, and the sample of the noisy speech may be obtained by synthesizing a pure speech sample and noise. For example, the sample of the noisy speech can be obtained by synthesizing a pure speech sample and noise according to a signal-to-noise ratio. This may be specifically expressed by using the following formula:

$$y = s + α n$$

y is a sample of the noisy speech, s is a pure speech sample, n is noise, and α is a coefficient used to control the signal-to-noise ratio. The signal-to-noise ratio (SNR) is a ratio between energy of the pure speech sample and energy of the noise, and a unit of the signal-to-noise ratio is decibel (dB). The signal-to-noise ratio may be calculated according to the following formula:

$$S N R = 10 {log}_{10} \frac{{s}^{2}}{{n}^{2}}$$

To obtain a sample of the noisy speech of a signal-to-noise ratio k dB, the energy of the noise needs to be controlled by the coefficient α, that is:

$$k = 10 {log}_{10} \frac{{s}^{2}}{{\left(α n\right)}^{2}}$$

By solving this formula, a value of the coefficient α can be obtained as:

$$α = \sqrt{\frac{{s}^{2}}{{10}^{\frac{k}{10}} {n}^{2}}}$$

Herein, the speech sample set may further include a reverberant speech sample or a near and far human speech sample. The noise reduction model obtained through training is not only suitable for processing a noisy speech, but also suitable for processing a speech with reverberation and a far and near human speech, thus enhancing the scope of application of the model and improving the robustness of the model.

A second step is as follows: using the sample of the noisy speech as an input of the short-time Fourier transform layer, performing subband division on a spectrum outputted by the short-time Fourier transform layer, using, as an input of the encoding network, a subband spectrum obtained after the subband division, performing subband restoration on a spectrum outputted by the decoding network, using, as an input of the short-time inverse Fourier transform layer, a spectrum obtained after the subband restoration, using the pure speech sample as an output target of the short-time Fourier inverse transform layer, and training the deep complex convolutional recurrent network by using a machine learning method, to obtain the noise reduction model.

Specifically, the second step can be performed according to the following sub-steps:

Sub-step S11: Select a sample of the noisy speech from the speech sample set, and obtain a pure speech sample synthesized with the sample of the noisy speech. Herein, the sample of the noisy speech may be selected randomly or according to a preset selection order.

Sub-step S12: Input the selected sample of the noisy speech to a short-time Fourier transform layer in the deep complex convolutional recurrent network, to obtain a spectrum of the sample of the noisy speech outputted by the short-time Fourier transform layer.

Sub-step S13: Perform subband division on the spectrum outputted by the Fourier transform layer, to obtain a subband spectrum of the spectrum. Refer to step 102 for the method of subband division, which will not be repeated herein.

Sub-step S14: Input the obtained subband spectrum to the encoding network.

Herein, the obtained subband spectrum can be specifically inputted to the first layer of encoder in the encoding network. The encoder of the encoding network can process the inputted data layer by layer. Each layer of encoder can input the processing result to a subsequent network structure connected to the layer of encoder (the next layer of encoder or the long short-term memory network, and a corresponding decoder thereof). For data processing processes of the encoder, the long short-term memory network, and the decoder, refer to the above description, and details will not be repeated herein.

Sub-step S15: Obtain the spectrum outputted by the decoding network.

Herein, the spectrum outputted by the decoding network is a subband spectrum outputted by the last layer of decoder. The subband spectrum may be a subband spectrum after noise reduction processing.

Sub-step S16: Perform subband restoration on the spectrum outputted by the decoding network, and input, to the short-time inverse Fourier transform layer, the spectrum obtained after subband restoration, to obtain a speech after noise reduction outputted by an inverse short-time Fourier transform layer (which can be denoted as s̃ ).

Sub-step S17: Determine a loss value based on the obtained noise-reduced speech and the pure speech sample (which can be denoted as s) corresponding to the selected sample of the noisy speech.

Herein, the loss value is a value of a loss function, and the loss function is a non-negative real-valued function that can be used to represent a difference between a detection result and a real result. In general, the smaller loss value indicates the better robustness of the model. The loss function can be set according to actual needs. For example, a scale-invariant source-to-noise ratio (SI-SNR) can be used as the loss function to calculate a loss value. Refer to the formula below:

$$S I - S N R = 10 {log}_{10} \left(\frac{{\left‖{S}_{\text{target}}\right‖}_{2}^{2}}{{\left‖{e}_{\text{noise}}\right‖}_{2}^{2}}\right)$$

$${S}_{\text{target}} = \frac{\left〈\tilde{s} , s\right〉 ⋅ s}{{\left‖s\right‖}_{2}^{2}}$$

$${e}_{\text{noise}} = \tilde{s} - {S}_{\text{target}}$$

〈s̃,s〉 represents the correlation between noise-reduced speech (s̃) and a pure speech sample (s), and can be obtained by using a common similarity calculation method.

Sub-step S18: Update a parameter of the deep complex convolutional recurrent network based on the loss value.

Herein, a backpropagation algorithm can be used to obtain a gradient of the loss value relative to the model parameter, and then a gradient descent algorithm can be used to update the model parameter based on the gradient. Specifically, a chain rule and a back propagation algorithm (BP algorithm) can be used to obtain the gradient of the loss value relative to the parameter of each layer of the initial model. In embodiments consistent with the present disclosure, the backpropagation algorithm may also be called an error backpropagation (BP) algorithm or an error backpropagation algorithm. The backpropagation algorithm includes two processes: the forward propagation of the signal and the backpropagation of the error (which can be represented by the loss value). In a feed forward network, the input signal is inputted through an input layer, and is outputted by an output layer through the hidden layer calculation. If there is an error between the output value and a marked value, the error is backpropagated from the output layer to the input layer. In a process of backpropagating the error, a gradient descent algorithm can be used to adjust a neuron weight (for example, a parameter of the convolution kernel in the convolution layer) based on the calculated gradient.

Sub-step S19: Detect whether the training of the deep complex convolutional recurrent network is completed.

In embodiments consistent with the present disclosure, there are several methods for determining whether the training of the deep complex convolutional recurrent network is completed. As an example, when the loss value converges below a preset value, it may be determined that the training is completed. As another example, if a number of training times of the deep complex convolutional recurrent network is equal to a preset number of times, it may be determined that the training is completed.

If the training of the deep complex convolutional recurrent network is not completed, a next sample of the noisy speech can be extracted from the speech sample set, and the deep complex convolutional recurrent network with an adjusted parameter can continue to execute sub-step S12, until training of the deep complex convolutional recurrent network is completed.

Sub-step S20: If the training is completed, use the trained deep complex convolutional recurrent network as the noise reduction model.

By constructing the short-time Fourier transform layer and the inverse short-time Fourier transform layer in the deep complex convolutional recurrent network, a short-time Fourier transform operation and an inverse short-time Fourier transform operation can be implemented through convolution, and can be processed by a graphics processing unit (GPU), thereby increasing the speed of model training.

In some embodiments consistent with this disclosure, the noise reduction model can be obtained by training the deep complex convolutional recurrent network shown in FIG. 3. In this case, when obtaining the first spectrum of the noisy speech in the complex number domain, the noisy speech can be directly inputted to the short-time Fourier transform layer in the pre-trained noise reduction model, so that the first spectrum of the noisy speech in the complex number domain can be obtained.

In some embodiments consistent with this disclosure, the noise reduction model can be obtained by training the deep complex convolutional recurrent network shown in FIG. 3. In this case, in obtaining of the second subband spectrum, the first subband spectrum can be inputted to the encoding network in the pre-trained noise reduction model, so that the spectrum outputted by the decoding network in the noise reduction model can be used as the second subband spectrum of the target speech of the noisy speech in the complex number domain.

In some embodiments consistent with this disclosure, to avoid residual noise in the synthesized target speech, after synthesizing the target speech, the executive body can also use a post-filtering algorithm to filter the target speech, to obtain the enhanced target speech. Since the filtering process can achieve the effect of noise reduction, the target speech can be enhanced, and thus the enhanced target speech can be obtained. By filtering the target speech, the speech noise reduction effect can be further improved.

Step 104: Perform subband restoration on the second subband spectrum to obtain a second spectrum in the complex number domain.

In this embodiment, the execution body may perform subband restoration on the second subband spectrum, to obtain the second spectrum in the complex number domain. Herein, the second subband spectrum can be directly spliced to obtain the second spectrum in the complex number domain.

Step 105: Synthesize the target speech based on the second spectrum.

In this embodiment, the execution body may convert the second spectrum of the target speech in the complex number domain into a speech signal in the time domain, thereby synthesizing the target speech. As an example, if the time-frequency analysis of the noisy speech is performed through short-time Fourier transform, the inverse transform of short-time Fourier transform can be performed on the second spectrum of the target speech in the complex number domain, to synthesize the target speech. The target speech is a speech obtained after performing noise reduction on the noisy speech, that is, an estimated pure speech.

In some embodiments consistent with this disclosure, the noise reduction model can be obtained by training the deep complex convolutional recurrent network shown in FIG. 3. In this case, in synthesizing of the target speech based on the second spectrum, the second spectrum may be inputted to the short-time inverse Fourier transform layer in the pre-trained noise reduction model, to obtain the target speech.

In embodiments of this application, a first spectrum of a noisy speech in a complex number domain is obtained; then subband division is performed on the first spectrum to obtain a first subband spectrum in the complex number domain; then the first subband spectrum is processed based on a pre-trained noise reduction model to obtain a second subband spectrum of a target speech in the noisy speech in the complex number domain; then subband restoration is performed for the second subband spectrum to obtain a second spectrum in the complex number domain; and the target speech is finally synthesized based on the second spectrum. Since subband division is performed on the first spectrum of the noisy speech in the complex number domain before noise reduction processing, both the high and low frequency information in the noisy speech can be effectively processed, the imbalance (for example, severe loss of high frequency speech information) of the high and low frequency information in the speech can be resolved, and the clarity of the speech after noise reduction is improved.

Further, the deep complex convolutional recurrent network used to train the noise reduction model includes an encoding network in the complex number domain, a decoding network in the complex number domain, and a long short-term memory network in the complex number domain. By setting the first real part convolution kernel and the first imaginary part convolution kernel at the complex convolution layer of each complex encoder in the encoding network, the complex encoder can respectively process the real part and the imaginary part of the spectrum. Then, output results of the real part and the imaginary part are correlated based on a complex multiplication rule, which can effectively improve the estimation accuracy of the real part and the imaginary part. By setting the first long short-term memory network and the second long short-term memory network, the long short-term memory networks can respectively process the real part and the imaginary part of the spectrum. Then, output results of the real part and the imaginary part are correlated based on a complex multiplication rule, which can further effectively improve the estimation accuracy of the real part and the imaginary part. By setting the second real part convolution kernel and the second imaginary part convolution kernel at the complex deconvolution layer in each complex decoder of the decoding network, the complex decoder can respectively process the real part and the imaginary part of the spectrum. Then, output results of the real part and the imaginary part are correlated based on a complex multiplication rule, which can further effectively improve the estimation accuracy of the real part and the imaginary part.

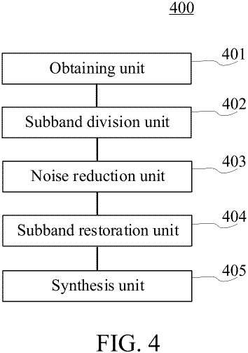

Further referring to FIG. 4, as an implementation of the methods shown in the above figures, this application provides an embodiment of a speech processing apparatus, and the apparatus embodiment corresponds to the method embodiment shown in FIG. 1. The apparatus may be specifically applied to various electronic devices.

As shown in FIG. 4, the speech processing apparatus 400 in this embodiment includes: an obtaining unit 401, configured to obtain a first spectrum of a noisy speech in a complex number domain; a subband division unit 402, configured to perform subband division on the first spectrum to obtain a first subband spectrum in the complex number domain; a noise reduction unit 403, configured to process the first subband spectrum based on a pre-trained noise reduction model to obtain a second subband spectrum of a target speech in the noisy speech in the complex number domain; a subband restoration unit 404, configured to perform subband restoration on the second subband spectrum to obtain a second spectrum in the complex number domain; and a synthesis unit 405, configured to synthesize the target speech based on the second spectrum.

In some embodiments consistent with this disclosure, the obtaining unit 401 is further configured to perform short-time Fourier transform on the noisy speech to obtain the first spectrum of the noisy speech in the complex number domain; and the synthesis unit 405 is further configured to perform inverse transform of short-time Fourier transform on the second spectrum to obtain the target speech.

In some embodiments consistent with this disclosure, the subband division unit 402 is further configured to divide a frequency domain of the first spectrum into a plurality of subbands; and divide the first spectrum according to the divided subbands to obtain first subband spectra in one-to-one correspondence with the divided subbands.

In some embodiments consistent with this disclosure, the noise reduction model is obtained based on training of a deep complex convolutional recurrent network; the deep complex convolutional recurrent network includes an encoding network in the complex number domain, a decoding network in the complex number domain, and a long short-term memory network in the complex number domain, and the encoding network and the decoding network are connected through the long short-term memory network; the encoding network includes a plurality of layers of complex encoders, and each layer of complex encoder includes a complex convolution layer, a batch normalization layer, and an activation unit layer; the decoding network includes a plurality of layers of complex decoders, and each layer of complex decoder includes a complex deconvolution layer, a batch normalization layer, and an activation unit layer; and a number of layers of the complex encoder in the encoding network is the same as a number of layers of the complex decoder in the decoding network, and the complex encoder in the encoding network and the complex decoder in a reverse order in the decoding network are in a one-to-one correspondence and are connected.

In some embodiments consistent with this disclosure, the complex convolution layer includes a first real part convolution kernel and a first imaginary part convolution kernel; and the complex encoder is configured to perform the following operations: convolve a received real part and a received imaginary part through the first real part convolution kernel, to obtain a first output and a second output, and convolve the received real part and the received imaginary part through the first imaginary part convolution kernel, to obtain a third output and a fourth output; perform a complex multiplication operation on the first output, the second output, the third output, and the fourth output based on a complex multiplication rule, to obtain a first operation result in the complex number domain; sequentially process the first operation result through the batch normalization layer and the activation unit layer in the complex encoder, to obtain an encoding result in the complex number domain, where the encoding result includes a real part and an imaginary part; and inputting the real part and the imaginary part of the encoding result to a network structure of a next layer.

In some embodiments consistent with this disclosure, the long short-term memory network includes a first long short-term memory network and a second long short-term memory network; and the long short-term memory network is configured to perform the following operations: process, through the first long short-term memory network, a real part and an imaginary part in an encoding result outputted by the last layer of complex encoder, to obtain a fifth output and a sixth output, and process, through the second long short-term memory network, a real part and an imaginary part of an encoding result outputted by the last layer of complex encoder, to obtain a seventh output and an eighth output; perform a complex multiplication operation on the fifth output, the sixth output, the seventh output, and the eighth output based on a complex multiplication rule, to obtain a second operation result in the complex number domain, where the second operation result includes a real part and an imaginary part; and input the real part and the imaginary part of the second operation result to a first layer of complex decoder in the decoding network in the complex number domain.

In some embodiments consistent with this disclosure, the complex deconvolution layer includes a second real part convolution kernel and a second imaginary part convolution kernel; and the complex decoder is configured to perform the following operations: convolving a received real part and a received imaginary part through the second real part convolution kernel, to obtain a ninth output and a tenth output, and convolving the received real part and the received imaginary part through the second imaginary part convolution kernel, to obtain an eleventh output and a twelfth output; performing a complex multiplication operation on the ninth output, the tenth output, the eleventh output, and the twelfth output based on a complex multiplication rule, to obtain a third operation result in the complex number domain; sequentially processing the third operation result through the batch normalization layer and the activation unit layer in the complex decoder, to obtain a decoding result in the complex number domain, where the decoding result includes a real part and an imaginary part; and when there is a next layer of complex decoder, inputting the real part and the imaginary part in the decoding result to the next layer of complex decoder.

In some embodiments consistent with this disclosure, the deep complex convolutional recurrent network further includes a short-time Fourier transform layer and an inverse short-time Fourier transform layer; and the noise reduction model is obtained through training in the following steps: obtaining a speech sample set, where the speech sample set includes a sample of the noisy speech, and the sample of the noisy speech is obtained by synthesizing a pure speech sample and noise; and using the sample of the noisy speech as an input of the short-time Fourier transform layer, performing subband division on a spectrum outputted by the short-time Fourier transform layer, using, as an input of the encoding network, a subband spectrum obtained after the subband division, performing subband restoration on a spectrum outputted by the decoding network, using, as an input of the short-time inverse Fourier transform layer, a spectrum obtained after the subband restoration, using the pure speech sample as an output target of the short-time Fourier inverse transform layer, and training the deep complex convolutional recurrent network by using a machine learning method, to obtain the noise reduction model.

In some embodiments consistent with this disclosure, the obtaining unit 401 is further configured to: input the noisy speech to the short-time Fourier transform layer in the pre-trained noise reduction model, to obtain the first spectrum of the noisy speech in the complex number domain; and the synthesis unit 405 is further configured to input the second spectrum to the inverse short-time Fourier transform layer in the noise reduction model, to obtain the target speech.

In some embodiments consistent with this disclosure, the noise reduction unit 403 is further configured to input the first subband spectrum to the encoding network in the pre-trained noise reduction model, and use, as the second subband spectrum of the target speech in the noisy speech in the complex number domain, the spectrum outputted by the decoding network in the noise reduction model.

In some embodiments consistent with this disclosure, the apparatus further includes: a filtering unit, configured to filter the target speech based on a post-filtering algorithm to obtain the enhanced target speech.

In embodiments of this application, a first spectrum of a noisy speech in a complex number domain is obtained; then subband division is performed on the first spectrum to obtain a first subband spectrum in the complex number domain; then the first subband spectrum is processed based on a pre-trained noise reduction model to obtain a second subband spectrum of a target speech in the noisy speech in the complex number domain; then subband restoration is performed for the second subband spectrum to obtain a second spectrum in the complex number domain; and the target speech is finally synthesized based on the second spectrum. Since subband division is performed on the first spectrum of the noisy speech in the complex number domain before noise reduction processing, both the high and low frequency information in the noisy speech can be effectively processed, the imbalance (for example, severe loss of high frequency speech information) of the high and low frequency information in the speech can be resolved, and the clarity of the speech after noise reduction is improved.

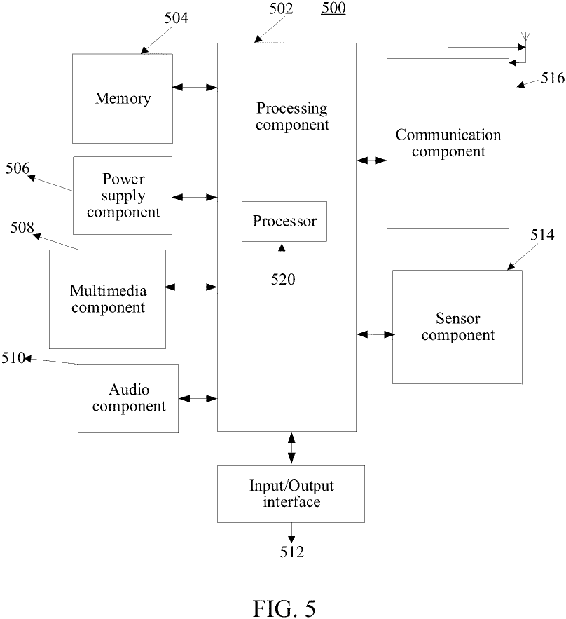

FIG. 5 is a block diagram of an input apparatus 500 according to an embodiment of the present disclosure. The apparatus 500 can be an intelligent terminal or a server. For example, the apparatus 500 may be a mobile phone, a computer, a digital broadcasting terminal, a messaging device, a game console, a tablet device, a medical device, a fitness facility, a personal digital assistant, or the like.

Referring to FIG. 5, the apparatus 500 may include one or more of the following components: a processing component 502, a storage 504, a power supply component 506, a multimedia component 508, an audio component 510, an input/output (I/O) interface 512, a sensor component 514, and a communication component 516.

The processing component 502 usually controls the whole operation of the apparatus 500, for example, operations associated with displaying, a phone call, data communication, a camera operation, and a recording operation. The processing component 502 may include one or more processors 520 to execute instructions, to complete all or some steps of the foregoing method. In addition, the processing component 502 may include one or more modules, to facilitate the interaction between the processing component 502 and other components. For example, the processing component 502 may include a multimedia module, to facilitate the interaction between the multimedia component 508 and the processing component 502.

The memory 504 is configured to store various types of data to support operations on the apparatus 500. Examples of the data include instructions, contact data, phonebook data, messages, pictures, videos, and the like of any application program or method used to be operated on the apparatus 500. The memory 504 can be implemented by any type of volatile or non-volatile storage device or a combination thereof, for example, a static random access memory (SRAM), an electrically erasable programmable read-only memory (EPROM), a programmable read-only memory (PROM), a read-only memory (ROM), a magnetic memory, a flash memory, a magnetic disc, or an optical disc.

The power supply component 506 provides power to various components of the apparatus 500. The power supply component 506 may include a power supply management system, one or more power supplies, and other components associated with generating, managing and allocating power for the apparatus 500.

The multimedia component 508 includes a screen providing an output interface between the apparatus 500 and a user. In some embodiments, the screen may include a liquid crystal display (LCD) and a touch panel (TP). If the screen includes a touch panel, the screen may be implemented as a touchscreen, to receive an input signal from the user. The touch panel includes one or more touch sensors to sense touching, sliding, and gestures on the touch panel. The touch sensor may not only sense the boundary of touching or sliding operations, but also detect duration and pressure related to the touching or sliding operations. In some embodiments, the multimedia component 508 includes a front camera and/or a rear camera. When the apparatus 500 is in an operation mode, such as a shoot mode or a video mode, the front camera and/or the rear camera may receive external multimedia data. Each front camera and rear camera may be a fixed optical lens system or have a focal length and an optical zooming capability.

The audio component 510 is configured to output and/or input an audio signal. For example, the audio component 510 includes a microphone (MIC), and when the apparatus 500 is in an operation mode, for example a call mode, a recording mode, and a speech identification mode, the MIC is configured to receive an external audio signal. The received audio signal may be further stored in the memory 504 or sent through the communication component 516. In some embodiments, the audio component 510 further includes a loudspeaker, configured to output an audio signal.

The I/O interface 512 provides an interface between the processing component 502 and an external interface module. The external interface module may be a keyboard, a click wheel, buttons, or the like. The buttons may include, but is not limited to: a homepage button, a volume button, a start-up button, and a locking button.

The sensor component 514 includes one or more sensors, configured to provide status evaluation in each aspect to the apparatus 500. For example, the sensor component 514 may detect an opened/closed status of the apparatus 500, and relative positioning of the component. For example, the component is a display and a small keyboard of the apparatus 500. The sensor component 514 may further detect the position change of the apparatus 500 or one component of the apparatus 500, the existence or nonexistence of contact between the user and the apparatus 500, the azimuth or acceleration/deceleration of the apparatus 500, and the temperature change of the apparatus 500. The sensor component 514 may include a proximity sensor, configured to detect the existence of nearby objects without any physical contact. The sensor component 514 may further include an optical sensor, for example a CMOS or CCD image sensor, that is used in an imaging application. In some embodiments, the sensor component 514 may further include an acceleration sensor, a gyroscope sensor, a magnetic sensor, a pressure sensor, or a temperature sensor.

The communication component 516 is configured to facilitate communication in a wired or wireless method between the apparatus 500 and other devices. The apparatus 500 may access a wireless network based on communication standards, for example Wi-Fi, 2G, or 3G, or a combination thereof. In one embodiment, the communication component 516 receives a broadcast signal or broadcast related information from an external broadcast management system via a broadcast channel. In one embodiment, the communication component 516 further includes a near field communication (NFC) module, to promote short range communication. For example, the NFC module may be implemented based on a radio frequency identification (RFID) technology, an infrared data association (IrDA) technology, an ultra wideband (UWB) technology, a Bluetooth (BT) technology, and other technologies.

In one embodiment, the apparatus 500 can be implemented as one or more application specific integrated circuit (ASIC), a digital signal processor (DSP), a digital signal processing device (DSPD), a programmable logic device (PLD), a field programmable gate array (FPGA), a controller, a micro-controller, a microprocessor or other electronic element, so as to perform the above method.

In one embodiment, a non-transitory computer readable storage medium including instructions, for example, a memory 504 including instructions, is further provided, and the foregoing instructions may be executed by a processor 520 of the apparatus 500 to complete the above method. For example, the non-transitory computer readable storage medium may be a ROM, a RAM, a CD-ROM, a magnetic tape, a floppy disk, an optical data storage device, or the like.

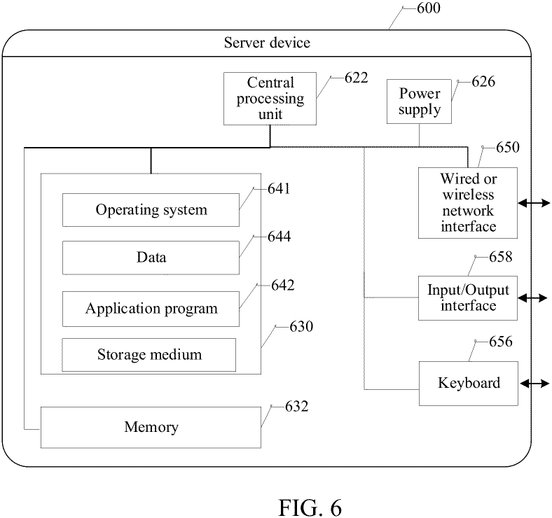

FIG. 6 is a schematic structural diagram of a server according to an embodiment of this application. The server 600 may greatly differ as configuration or performance differs, may include one or more central processing units (CPUs) 622 (for example, one or more processors), a memory 632, and one or more storage mediums 630 storing an application program 642 or data 644 (for example, one or more mass storage devices). The memories 632 and the storage mediums 630 may be used for transient storage or permanent storage. A program stored in the storage medium 630 may include one or more modules (which are not marked in the figure), and each module may include a series of instruction operations on the server. Further, the central processing unit 622 may be configured to communicate with the storage medium 630, and perform, on the server 600, a series of instructions and operations in the storage medium 630.

The server 600 may further include one or more power supplies 626, one or more wired or wireless network interfaces 650, one or more input/output interfaces 658, one or more keyboards 656, and/or one or more operating systems 641, for example, Windows ServerTM, Mac OS XTM, UnixTM, LinuxTM, and FreeBSDTM.

A non-transitory computer-readable storage medium is provided. When instructions in the storage medium are executed by a processor of an apparatus (an intelligent terminal or server), the apparatus can execute the speech processing method. The method includes: obtaining a first spectrum of a noisy speech in a complex number domain; performing subband division on the first spectrum to obtain a first subband spectrum in the complex number domain; processing the first subband spectrum based on a pre-trained noise reduction model to obtain a second subband spectrum of a target speech in the noisy speech in the complex number domain; performing subband restoration on the second subband spectrum to obtain a second spectrum in the complex number domain; and synthesizing the target speech based on the second spectrum.

In some embodiments, the obtaining a first spectrum of a noisy speech in a complex number domain includes: performing short-time Fourier transform on the noisy speech to obtain the first spectrum of the noisy speech in the complex number domain; and the synthesizing the target speech based on the second spectrum includes: performing inverse transform of short-time Fourier transform on the second spectrum to obtain the target speech.

In some embodiments, the performing subband division on the first spectrum to obtain a first subband spectrum in the complex number domain includes: dividing a frequency domain of the first spectrum into a plurality of subbands; and dividing the first spectrum according to the divided subbands to obtain first subband spectra in one-to-one correspondence with the divided subbands.

In some embodiments, the noise reduction model is obtained based on training of a deep complex convolutional recurrent network; the deep complex convolutional recurrent network includes an encoding network in the complex number domain, a decoding network in the complex number domain, and a long short-term memory network in the complex number domain, and the encoding network and the decoding network are connected through the long short-term memory network; the encoding network includes a plurality of layers of complex encoders, and each layer of complex encoder includes a complex convolution layer, a batch normalization layer, and an activation unit layer; the decoding network includes a plurality of layers of complex decoders, and each layer of complex decoder includes a complex deconvolution layer, a batch normalization layer, and an activation unit layer; and a number of layers of the complex encoder in the encoding network is the same as a number of layers of the complex decoder in the decoding network, and the complex encoder in the encoding network and the complex decoder in a reverse order in the decoding network are in a one-to-one correspondence and are connected.

In some embodiments, the complex convolution layer includes a first real part convolution kernel and a first imaginary part convolution kernel; and the complex encoder is configured to perform the following operations: convolve a received real part and a received imaginary part through the first real part convolution kernel, to obtain a first output and a second output, and convolve the received real part and the received imaginary part through the first imaginary part convolution kernel, to obtain a third output and a fourth output; perform a complex multiplication operation on the first output, the second output, the third output, and the fourth output based on a complex multiplication rule, to obtain a first operation result in the complex number domain; sequentially process the first operation result through the batch normalization layer and the activation unit layer in the complex encoder, to obtain an encoding result in the complex number domain, where the encoding result includes a real part and an imaginary part; and inputting the real part and the imaginary part of the encoding result to a network structure of a next layer.

In some embodiments, the long short-term memory network includes a first long short-term memory network and a second long short-term memory network; and the long short-term memory network is configured to perform the following operations: process, through the first long short-term memory network, a real part and an imaginary part in an encoding result outputted by the last layer of complex encoder, to obtain a fifth output and a sixth output, and process, through the second long short-term memory network, a real part and an imaginary part of an encoding result outputted by the last layer of complex encoder, to obtain a seventh output and an eighth output; perform a complex multiplication operation on the fifth output, the sixth output, the seventh output, and the eighth output based on a complex multiplication rule, to obtain a second operation result in the complex number domain, where the second operation result includes a real part and an imaginary part; and input the real part and the imaginary part of the second operation result to a first layer of complex decoder in the decoding network in the complex number domain.

In some embodiments, the complex deconvolution layer includes a second real part convolution kernel and a second imaginary part convolution kernel; and the complex decoder is configured to perform the following operations: convolving a received real part and a received imaginary part through the second real part convolution kernel, to obtain a ninth output and a tenth output, and convolving the received real part and the received imaginary part through the second imaginary part convolution kernel, to obtain an eleventh output and a twelfth output; performing a complex multiplication operation on the ninth output, the tenth output, the eleventh output, and the twelfth output based on a complex multiplication rule, to obtain a third operation result in the complex number domain; sequentially processing the third operation result through the batch normalization layer and the activation unit layer in the complex decoder, to obtain a decoding result in the complex number domain, where the decoding result includes a real part and an imaginary part; and when there is a next layer of complex decoder, inputting the real part and the imaginary part in the decoding result to the next layer of complex decoder.

In some embodiments, the deep complex convolutional recurrent network further includes a short-time Fourier transform layer and an inverse short-time Fourier transform layer; and the noise reduction model is obtained through training in the following steps: obtaining a speech sample set, where the speech sample set includes a sample of the noisy speech, and the sample of the noisy speech is obtained by synthesizing a pure speech sample and noise; and using the sample of the noisy speech as an input of the short-time Fourier transform layer, performing subband division on a spectrum outputted by the short-time Fourier transform layer, using, as an input of the encoding network, a subband spectrum obtained after the subband division, performing subband restoration on a spectrum outputted by the decoding network, using, as an input of the short-time inverse Fourier transform layer, a spectrum obtained after the subband restoration, using the pure speech sample as an output target of the short-time Fourier inverse transform layer, and training the deep complex convolutional recurrent network by using a machine learning method, to obtain the noise reduction model.

In some embodiments, the obtaining a first spectrum of a noisy speech in a complex number domain includes: inputting the noisy speech to the short-time Fourier transform layer in the pre-trained noise reduction model, to obtain the first spectrum of the noisy speech in the complex number domain; and the synthesizing the target speech based on the second spectrum includes: inputting the second spectrum to the inverse short-time Fourier transform layer in the noise reduction model, to obtain the target speech.

In some embodiments, the processing the first subband spectrum based on a pre-trained noise reduction model to obtain a second subband spectrum of a target speech in the noisy speech in the complex number domain includes: inputting the first subband spectrum to the encoding network in the pre-trained noise reduction model, and using, as the second subband spectrum of the target speech in the noisy speech in the complex number domain, the spectrum outputted by the decoding network in the noise reduction model.

In some embodiments, the apparatus is configured to be executed by one or more processors, and the one or more programs include instructions for performing the following operations: filtering the target speech based on a post-filtering algorithm to obtain the enhanced target speech.

It is to be noted that the speech processing apparatus provided in the foregoing embodiments is illustrated with an example of functional units or modules. In embodiments consistent with the present disclosure, the function distribution may be implemented by different functional modules or units according to requirements, that is, an internal structure of the computer device is divided into different functional modules or units, to implement all or some of the functions described above. A functional unit or functional module may be implemented by hardware components, software components, or a combination of both hardware and software components. In addition, the speech processing apparatus and the speech processing method embodiments provided in the above embodiments belong to the same concept. For the specific implementation process, reference may be made to the log execution method embodiments, and details are not described herein again.

A person skilled in the art can easily figure out another implementation solution of this application after considering the specification and practicing this application that is disclosed herein. This application is intended to cover any variation, use, or adaptive change of this application. These variations, uses, or adaptive changes follow the general principles of this application and include common general knowledge or common technical means, which are not disclosed in the present disclosure, in the art. The specification and the embodiments are considered as merely exemplary, and the real scope and spirit of this application are pointed out in the following claims.

It is understood that this application is not limited to the precise structures described above and shown in the accompanying drawings, and various modifications and changes can be made without departing from the scope of this application. The scope of this application is subject only to the appended claims.

The foregoing descriptions are embodiments of this application, but are not intended to limit this application. Any modification, equivalent replacement, or improvement made within the spirit and principle of this application shall fall within the protection scope of this application.

The speech processing method and the speech processing apparatus provided in this application are described above in detail. Although the principles and implementations of this application are described by using specific examples in this specification, the descriptions of the foregoing embodiments are merely intended to help understand the method and the core idea of the method of this application. Meanwhile, a person skilled in the art may make modifications to the specific implementations and application range according to the idea of this application. In conclusion, the content of this specification is not construed as a limitation to this application.

What is claimed is:

1. A speech processing method, comprising:
obtaining a first spectrum of a noisy speech in a complex number domain;
performing subband division on the first spectrum to obtain a first subband spectrum in the complex number domain;
processing the first subband spectrum based on a pre-trained noise reduction model to obtain a second subband spectrum of a target speech in the noisy speech in the complex number domain;
performing subband restoration on the second subband spectrum to obtain a second spectrum in the complex number domain; and
synthesizing the target speech based on the second spectrum.

2. The method according to claim 1, wherein the obtaining a first spectrum of a noisy speech in a complex number domain comprises:
performing short-time Fourier transform on the noisy speech to obtain the first spectrum of the noisy speech in the complex number domain; and
the synthesizing the target speech based on the second spectrum comprises:
performing inverse transform of short-time Fourier transform on the second spectrum to obtain the target speech.

3. The method according to claim 1, wherein the performing subband division on the first spectrum to obtain a first subband spectrum in the complex number domain comprises:
dividing a frequency domain of the first spectrum into a plurality of subbands; and
dividing the first spectrum according to the divided subbands to obtain first subband spectra in one-to-one correspondence with the divided subbands.

4. The method according to claim 1, wherein the noise reduction model is obtained based on training of a deep complex convolutional recurrent network;
the deep complex convolutional recurrent network comprises an encoding network in the complex number domain, a decoding network in the complex number domain, and a long short-term memory network in the complex number domain, and the encoding network and the decoding network are connected through the long short-term memory network;
the encoding network comprises a plurality of layers of complex encoders, and each layer of complex encoder comprises a complex convolution layer, a batch normalization layer, and an activation unit layer;
the decoding network comprises a plurality of layers of complex decoders, and each layer of complex decoder comprises a complex deconvolution layer, a batch normalization layer, and an activation unit layer; and
a number of layers of the complex encoder in the encoding network is the same as a number of layers of the complex decoder in the decoding network, and the complex encoder in the encoding network and the complex decoder in a reverse order in the decoding network are in a one-to-one correspondence and are connected.

5. The method according to claim 4, wherein the complex convolution layer comprises a first real part convolution kernel and a first imaginary part convolution kernel; and
the complex encoder is configured to perform the following operations:
convolving a received real part and a received imaginary part through the first real part convolution kernel, to obtain a first output and a second output, and convolving the received real part and the received imaginary part through the first imaginary part convolution kernel, to obtain a third output and a fourth output;
performing a complex multiplication operation on the first output, the second output, the third output, and the fourth output based on a complex multiplication rule, to obtain a first operation result in the complex number domain;
sequentially processing the first operation result through the batch normalization layer and the activation unit layer in the complex encoder, to obtain an encoding result in the complex number domain, wherein the encoding result comprises a real part and an imaginary part; and
inputting the real part and the imaginary part of the encoding result to a network structure of a next layer.

6. The method according to claim 5, wherein the long short-term memory network comprises a first long short-term memory network and a second long short-term memory network; and
the long short-term memory network is configured to perform the following operations:
processing, through the first long short-term memory network, a real part and an imaginary part in an encoding result outputted by the last layer of complex encoder, to obtain a fifth output and a sixth output, and processing, through the second long short-term memory network, a real part and an imaginary part of an encoding result outputted by the last layer of complex encoder, to obtain a seventh output and an eighth output;
performing a complex multiplication operation on the fifth output, the sixth output, the seventh output, and the eighth output based on a complex multiplication rule, to obtain a second operation result in the complex number domain, wherein the second operation result comprises a real part and an imaginary part; and
inputting the real part and the imaginary part of the second operation result to a first layer of complex decoder in the decoding network in the complex number domain.

7. The method according to claim 6, wherein the complex deconvolution layer comprises a second real part convolution kernel and a second imaginary part convolution kernel; and
the complex decoder is configured to perform the following operations:
convolving a received real part and a received imaginary part through the second real part convolution kernel, to obtain a ninth output and a tenth output, and convolving the received real part and the received imaginary part through the second imaginary part convolution kernel, to obtain an eleventh output and a twelfth output;
performing a complex multiplication operation on the ninth output, the tenth output, the eleventh output, and the twelfth output based on a complex multiplication rule, to obtain a third operation result in the complex number domain;
sequentially processing the third operation result through the batch normalization layer and the activation unit layer in the complex decoder, to obtain a decoding result in the complex number domain, wherein the decoding result comprises a real part and an imaginary part; and
when there is a next layer of complex decoder, inputting the real part and the imaginary part in the decoding result to the next layer of complex decoder.

8. The method according to claim 4, wherein the deep complex convolutional recurrent network further comprises a short-time Fourier transform layer and an inverse short-time Fourier transform layer; and
the noise reduction model is obtained through training in the following steps:
obtaining a speech sample set, wherein the speech sample set comprises a sample of the noisy speech, and the sample of the noisy speech is obtained by synthesizing a pure speech sample and noise; and
using the sample of the noisy speech as an input of the short-time Fourier transform layer, performing subband division on a spectrum outputted by the short-time Fourier transform layer, using, as an input of the encoding network, a subband spectrum obtained after the subband division, performing subband restoration on a spectrum outputted by the decoding network, using, as an input of the short-time inverse Fourier transform layer, a spectrum obtained after the subband restoration, using the pure speech sample as an output target of the short-time Fourier inverse transform layer, and training the deep complex convolutional recurrent network by using a machine learning method, to obtain the noise reduction model.

9. The method according to claim 8, wherein the obtaining a first spectrum of a noisy speech in a complex number domain comprises:
inputting the noisy speech to the short-time Fourier transform layer in the pre-trained noise reduction model, to obtain the first spectrum of the noisy speech in the complex number domain; and
the synthesizing the target speech based on the second spectrum comprises:
inputting the second spectrum to the inverse short-time Fourier transform layer in the noise reduction model, to obtain the target speech.

10. The method according to claim 8, wherein the processing the first subband spectrum based on a pre-trained noise reduction model to obtain a second subband spectrum of a target speech in the noisy speech in the complex number domain comprises:
inputting the first subband spectrum to the encoding network in the pre-trained noise reduction model, and using, as the second subband spectrum of the target speech in the noisy speech in the complex number domain, the spectrum outputted by the decoding network in the noise reduction model.

11. The method according to claim 1, wherein after the synthesizing the target speech, the method further comprises:
filtering the target speech based on a post-filtering algorithm to obtain the enhanced target speech.

12. A speech processing apparatus, comprising:
an obtaining unit, configured to obtain a first spectrum of a noisy speech in a complex number domain;
a subband division unit, configured to perform subband division on the first spectrum to obtain a first subband spectrum in the complex number domain;
a noise reduction unit, configured to process the first subband spectrum based on a pre-trained noise reduction model to obtain a second subband spectrum of a target speech in the noisy speech in the complex number domain;
a subband restoration unit, configured to perform subband restoration on the second subband spectrum to obtain a second spectrum in the complex number domain; and
a synthesis unit, configured to synthesize the target speech based on the second spectrum.

13. The apparatus according to claim 12, wherein the obtaining unit is further configured to:
perform short-time Fourier transform on the noisy speech to obtain the first spectrum of the noisy speech in the complex number domain; and
the synthesizing the target speech based on the second spectrum comprises:
performing inverse transform of short-time Fourier transform on the second spectrum to obtain the target speech.

14. The apparatus according to claim 12, wherein the subband division unit is further configured to:
divide a frequency domain of the first spectrum into a plurality of subbands; and
divide the first spectrum according to the divided subbands to obtain first subband spectra in one-to-one correspondence with the divided subbands.

15. The apparatus according to claim 12, wherein the noise reduction model is obtained based on training of a deep complex convolutional recurrent network;
the deep complex convolutional recurrent network comprises an encoding network in the complex number domain, a decoding network in the complex number domain, and a long short-term memory network in the complex number domain, and the encoding network and the decoding network are connected through the long short-term memory network;
the encoding network comprises a plurality of layers of complex encoders, and each layer of complex encoder comprises a complex convolution layer, a batch normalization layer, and an activation unit layer;
the decoding network comprises a plurality of layers of complex decoders, and each layer of complex decoder comprises a complex deconvolution layer, a batch normalization layer, and an activation unit layer; and
a number of layers of the complex encoder in the encoding network is the same as a number of layers of the complex decoder in the decoding network, and the complex encoder in the encoding network and the complex decoder in a reverse order in the decoding network are in a one-to-one correspondence and are connected.

16. The apparatus according to claim 15, wherein the complex convolution layer comprises a first real part convolution kernel and a first imaginary part convolution kernel; and
the complex encoder is configured to perform the following operations:
convolving a received real part and a received imaginary part through the first real part convolution kernel, to obtain a first output and a second output, and convolving the received real part and the received imaginary part through the first imaginary part convolution kernel, to obtain a third output and a fourth output;
performing a complex multiplication operation on the first output, the second output, the third output, and the fourth output based on a complex multiplication rule, to obtain a first operation result in the complex number domain;
sequentially processing the first operation result through the batch normalization layer and the activation unit layer in the complex encoder, to obtain an encoding result in the complex number domain, wherein the encoding result comprises a real part and an imaginary part; and
inputting the real part and the imaginary part of the encoding result to a network structure of a next layer.

17. The apparatus according to claim 16, wherein the long short-term memory network comprises a first long short-term memory network and a second long short-term memory network; and
the long short-term memory network is configured to perform the following operations:
processing, through the first long short-term memory network, a real part and an imaginary part in an encoding result outputted by the last layer of complex encoder, to obtain a fifth output and a sixth output, and processing, through the second long short-term memory network, a real part and an imaginary part of an encoding result outputted by the last layer of complex encoder, to obtain a seventh output and an eighth output;
performing a complex multiplication operation on the fifth output, the sixth output, the seventh output, and the eighth output based on a complex multiplication rule, to obtain a second operation result in the complex number domain, wherein the second operation result comprises a real part and an imaginary part; and
inputting the real part and the imaginary part of the second operation result to a first layer of complex decoder in the decoding network in the complex number domain.

18. The apparatus according to claim 17, wherein the complex deconvolution layer comprises a second real part convolution kernel and a second imaginary part convolution kernel; and
the complex decoder is configured to perform the following operations:
convolving a received real part and a received imaginary part through the second real part convolution kernel, to obtain a ninth output and a tenth output, and convolving the received real part and the received imaginary part through the second imaginary part convolution kernel, to obtain an eleventh output and a twelfth output;
performing a complex multiplication operation on the ninth output, the tenth output, the eleventh output, and the twelfth output based on a complex multiplication rule, to obtain a third operation result in the complex number domain;
sequentially processing the third operation result through the batch normalization layer and the activation unit layer in the complex decoder, to obtain a decoding result in the complex number domain, wherein the decoding result comprises a real part and an imaginary part; and
when there is a next layer of complex decoder, inputting the real part and the imaginary part in the decoding result to the next layer of complex decoder.

19. The apparatus according to claim 15, wherein the deep complex convolutional recurrent network further comprises a short-time Fourier transform layer and an inverse short-time Fourier transform layer; and
the noise reduction model is obtained through training in the following steps:
obtaining a speech sample set, wherein the speech sample set comprises a sample of the noisy speech, and the sample of the noisy speech is obtained by synthesizing a pure speech sample and noise; and
using the sample of the noisy speech as an input of the short-time Fourier transform layer, performing subband division on a spectrum outputted by the short-time Fourier transform layer, using, as an input of the encoding network, a subband spectrum obtained after the subband division, performing subband restoration on a spectrum outputted by the decoding network, using, as an input of the short-time inverse Fourier transform layer, a spectrum obtained after the subband restoration, using the pure speech sample as an output target of the short-time Fourier inverse transform layer, and training the deep complex convolutional recurrent network by using a machine learning method, to obtain the noise reduction model.

20. A non-transitory computer-readable medium, storing a computer program thereon, and the program implementing the method comprising:
obtaining a first spectrum of a noisy speech in a complex number domain;
performing subband division on the first spectrum to obtain a first subband spectrum in the complex number domain;
processing the first subband spectrum based on a pre-trained noise reduction model to obtain a second subband spectrum of a target speech in the noisy speech in the complex number domain;
performing subband restoration on the second subband spectrum to obtain a second spectrum in the complex number domain; and
synthesizing the target speech based on the second spectrum.
